(19) United States
(12) Patent Application Publication
(10) Pub. No.: US 2026/0093951 A1
(43) Pub. Date: Apr. 2, 2026

(54) METHOD AND SYSTEM FOR INDUSTRIAL EQUIPMENT FAULT DIAGNOSIS BASED ON GRAPH STRUCTURE JOINT OPTIMIZATION

(71) Applicant: YANTAI UNIVERSITY, Yantai (CN)

(72) Inventors: Zhaowei LIU, Yantai (CN); Miaosi XIE, Yantai (CN); Tengjiang WANG, Yantai (CN); Tao WANG, Yantai (CN); Qiang FU, Yantai (CN); Shuli ZHANG, Yantai (CN); Yanle LIU, Yantai (CN); Weiqing YAN, Yantai (CN); Anzuo JIANG, Yantai (CN); Zhenhua MENG, Yantai (CN); Yongchao SONG, Yantai (CN); Yao SHAN, Yantai (CN); Heng LI, Yantai (CN)

(73) Assignee: YANTAI UNIVERSITY, Yantai (CN)

(21) Appl. No.: 19/279,953

(22) Filed: Jul. 24, 2025

(30) Foreign Application Priority Data
Sep. 29, 2024 (CN) 2024113647121

(51) Int. Cl. G06N 3/042; G06N 3/047; G06N 3/0475

(52) U.S. Cl. CPC G06N 3/042; G06N 3/047; G06N 3/0475

(57) ABSTRACT

This disclosure relates to the technical field of fault diagnosis, in particular, to a method and system for industrial equipment fault diagnosis based on graph structure joint optimization. The method includes: acquiring an original equipment dataset; constructing an original graph structure based on the original equipment dataset; extracting two basic views based on the original graph structure, calculating graph node embeddings of the basic views using a GCN, and recalculating a probability of an edge in the graph structure based on the graph node embeddings; performing view fusion based on the probability of the edge in the graph structure to obtain a preliminarily optimized view; and processing a fused view through a GAT network to obtain an enhanced view. According to this disclosure, the problems of low prediction accuracy, poor robustness, the like in traditional fault diagnosis are optimized, and thus the stability of industrial Internet equipment is greatly improved.

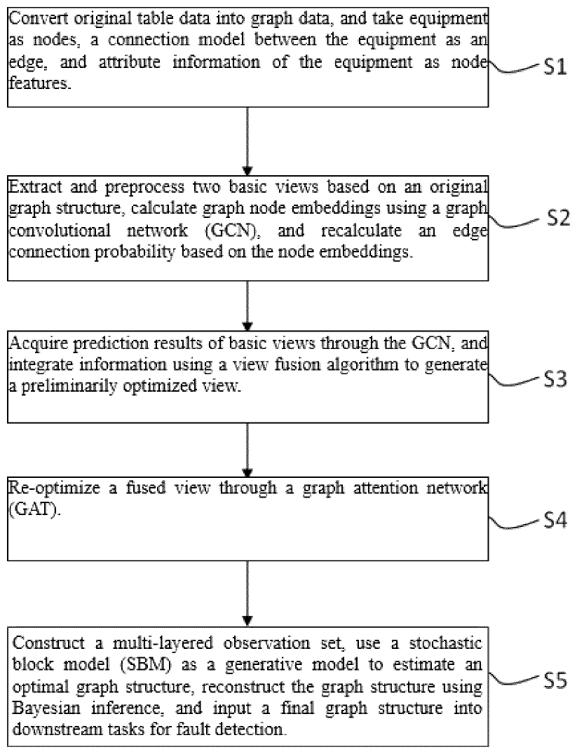

### CROSS-REFERENCE TO RELATED APPLICATIONS

The application claims priority to Chinese patent application No. 2024113647121, filed on Sep. 29, 2024, the entire contents of which are incorporated herein by reference.

### TECHNICAL FIELD

This disclosure relates to the technical field of fault diagnosis, and in particular, to a method and system for industrial equipment fault diagnosis based on graph structure joint optimization.

### BACKGROUND

With the rapid development of fault diagnosis for industrial Internet equipment, systems have become an important tool for equipment maintenance and management. By analyzing the historical data, operating states, and fault records of the equipment, fault diagnosis systems can provide operators with timely early warnings and repair suggestions, thereby improving the stability and efficiency of equipment operation.

At present, traditional fault diagnosis methods, such as rule-based methods, perform poorly when dealing with complex modes and changes of equipment faults, while statistical models are often insufficiently comprehensive in capturing the in-depth operating states and fault modes of the equipment. In addition, existing diagnosis systems face performance bottlenecks in terms of accuracy, real-time performance, and large-scale data processing.

Graph neural network (GNN), as an advanced technology for processing graph structure data, has shown potential in equipment fault diagnosis. However, when GNN is directly applied to fault diagnosis, there are significant problems such as sparse graph structures, data noise, and limitations in computing resources. The sparsity of the graph structures makes it difficult for GNN to capture potential relationships between the equipment and faults, while the data noise may cause the models to learn inaccurate features. To improve the effectiveness of the fault diagnosis systems, how to effectively use GNN for graph data modeling and to solve these problems has become the focus of current research and applications.

Existing GNN algorithms usually involve directly inputting an original graph structure into the network for training, which leads to two major problems: on the one hand, extracting effective graph structures from original data and fusing them poses a challenge. Graph data processed from real-world data often has problems such as noise and incomplete node features, which makes it complex to construct accurate graph structures and extract useful features therefrom. On the other hand, the GNN algorithms are based on a message passing mechanism, which requires the models to continuously aggregate information from multi-hop neighborhoods of nodes during the training process. This process requires processing a large volume of node data, which slows down the training and inference speeds of GNN models. Moreover, since the GNN models are typically considered as black boxes, their internal feature transformations and decision-making processes lack transparency. Therefore, to address these problems of GNN in practical applications, improvements in terms of efficiency, interpretability, and model complexity are needed.

### SUMMARY

To solve the above-mentioned problems, this disclosure provides a method and system for industrial equipment fault diagnosis based on graph structure joint optimization.

In a first aspect, a method for industrial equipment fault diagnosis based on graph structure joint optimization provided by this disclosure adopts the following technical solution:

A method for industrial equipment fault diagnosis based on graph structure joint optimization, including:
acquiring an original equipment dataset;
constructing an original graph structure based on the original equipment dataset;
extracting two basic views based on the original graph structure, calculating graph node embeddings of the basic views using a GCN, and recalculating a probability of an edge in the graph structure based on the graph node embeddings;
performing view fusion based on the probability of the edge in the graph structure to obtain a preliminarily optimized view;
processing a fused view through a GAT network to obtain an enhanced view; and
using a stochastic block model as a generative model, and iteratively optimizing the enhanced view using Bayesian inference and an expectation maximization algorithm to reconstruct the graph structure.

Further, the constructing an original graph structure based on the original equipment dataset includes making collected original equipment data into a graph dataset suitable for network training, taking equipment as nodes, taking contact information between the equipment as the edge, and taking various data and attributes of the equipment as node features.

Further, the extracting two basic views based on the original graph structure, calculating graph node embeddings of the basic views using a GCN includes extracting the two basic views from the original graph structure: an adjacency matrix and a transition matrix, performing preliminary processing on the two selected basic views, and acquiring view embeddings using the graph convolutional network GCN:

$${Q}^{1} = σ ( GCN ( {V}_{1} , X ) )$$

$${Q}^{2} = σ ( GCN ( {V}_{2} , X ) )$$

where σ is a nonlinear activation function that introduces a nonlinear transformation to improve an expression ability and a complex data learning ability of the network.

Further, the recalculating a probability of an edge in the graph structure based on the graph node embeddings includes for a target node, connecting an embedding thereof to an embedding of another node, then normalizing weights of the nodes to obtain a probability that an edge exists among node pairs, combining overall probabilities to obtain a probability matrix, and combining the probability matrix with the original graph structure to obtain processed basic views.

Further, the performing view fusion based on the probability of the edge in the graph structure to obtain a preliminarily optimized view includes processing the fused view through a graph attention network GAT, applying a self-attention mechanism to enhance interactions and feature expressions among the nodes, and performing dynamic evaluation and weighted aggregation on features of neighbor nodes to generate an enhanced view with more information.

Further, the applying a self-attention mechanism to enhance interactions and feature expressions among the nodes includes calculating an attention coefficient between the node pairs:

$${e}_{ij} = d ( [ {Mh}_{i} ‖ {Mh}_{j} ] ) , j ∈ {N}_{i}$$

where M is a shared parameter, h represents the node features, and d is a real number parameter used to project high-dimensional features of a connection into a real number field.

Further, the using a stochastic block model as a generative model includes using the stochastic block model SBM as the generative model to simulate an optimal graph structure, a probability of a process of generating a simulated optimal graph structure G being formalized as:

$$P ( G \vert Ω , Z , {Y}_{L} ) = {\prod }_{i < j} {{Ω}_{{c}_{i} {c}_{j}}^{{G}_{ij}} ( 1 - {Ω}_{{c}_{i} {c}_{j}} )}^{1 - {G}_{ij}}$$

$${c}_{i} = \{ \begin{matrix}{y}_{i} & if {v}_{i} ∈ {𝒱}_{L} , \\ {z}_{i} & otherwise ,\end{matrix}$$

where the SBM divides the entire network into a plurality of communities, cᵢ represents a community to which a node i belongs, Ω is a parameter of the SBM, Ω_{c}_{ᵢ}cⱼ represents a probability that an edge exists between any node vᵢ in a community c and a node vⱼ in a community c; Y_{L} represents label information; and
Gᵢⱼ represents a probability that an edge exists between a node i and a node j in a simulated graph structure G, Z is a prediction obtained by performing softmax processing on an obtained node representation H, Zᵢ represents a prediction result of the node vᵢ, and yᵢ represents a true label of vᵢ; [symbol] _{L} represents all nodes of a training set; and if the node vᵢ has a label value, cᵢ thereof is taken to be the label value yᵢ, and if the node vᵢ has no label value, cᵢ thereof is taken to be a predicted value Zᵢ.

In a second aspect, a system for industrial equipment fault diagnosis based on graph structure joint optimization includes:
a data acquisition module, configured to acquire an original equipment dataset and construct an original graph structure based on the original equipment dataset;
an embedding module, configured to extract two basic views based on the original graph structure, calculate graph node embeddings of the basic views using a GCN, and recalculate a probability of an edge in the graph structure based on the graph node embeddings;
a fusion module, configured to perform view fusion based on the probability of the edge in the graph structure to obtain a preliminarily optimized view;
an enhancement module, configured to process a fused view through a GAT network to obtain an enhanced view; and
an optimization module, configured to use a stochastic block model as a generative model and iteratively optimize the enhanced view using Bayesian inference and an expectation maximization algorithm to reconstruct the graph structure, so as to obtain a final graph structure.

In a third aspect, this disclosure provides a computer-readable storage medium, having a plurality of instructions stored therein, where the instructions are adapted to be loaded by a processor of terminal equipment and to execute a method for industrial equipment fault diagnosis based on graph structure joint optimization described above.

In a fourth aspect, this disclosure provides terminal equipment, including a processor and a computer-readable storage medium, the processor being used for implementing various instructions, and the computer-readable storage medium being used for storing a plurality of instructions, where the instructions are adapted to be loaded by the processor and to execute a method for industrial equipment fault diagnosis based on graph structure joint optimization described above.

In summary, this disclosure has the following beneficial technical effects:

(1) According to this disclosure, artificial intelligence and deep learning algorithms are introduced, recommendation systems are combined with a GNN, and a series of technologies including graph structure learning algorithms, basic view processing, graph attention mechanisms, and probabilistic backtracking structures are utilized to implement fault diagnosis for the industrial Internet equipment.

(2) This disclosure proposes an advanced fault diagnosis scheme for industrial Internet equipment. By combining basic view fusion processing with the attention mechanisms, as well as integrating the Bayesian backtracking structure, the system optimizes the problems of low prediction accuracy, poor robustness, and the like in traditional fault diagnosis, thereby greatly improving the stability of the industrial Internet equipment.

(3) The problem of low compatibility between the dataset and the training model is solved. The basic views are extracted based on source data, and are encoded, reconstructed, and fused using GCN to obtain the preliminary view. Secondary optimization is performed using the GAT network, thus enhancing the expressiveness of the node information. Moreover, by introducing the Bayesian idea, an optimal graph framework is generated based on SBM, and the final graph structure is reconstructed using the node mapping, thereby improving the accuracy of downstream tasks.

### BRIEF DESCRIPTION OF THE DRAWINGS

The FIGURE is a schematic diagram of a method for industrial equipment fault diagnosis based on graph structure joint optimization according to Embodiment 1 of this disclosure.

### DETAILED DESCRIPTION OF THE EMBODIMENTS

This disclosure is further detailed below with reference to the accompanying drawings.

### Embodiment 1

Referring to the FIGURE, a method for industrial equipment fault diagnosis based on graph structure joint optimization of this embodiment includes:
S1: making a collected original equipment dataset into a graph dataset suitable for network training, taking equipment (machines, sensors, control systems, etc.) as nodes, taking contact information between the equipment as the edge, and taking various data and attributes of the equipment as node features;
S2: in an initial phase, extracting and preprocessing two basic views based on an original graph structure, calculating graph node embeddings using a GCN, and recalculating an edge connection probability based on the node embeddings;
S3: using the GCN network to obtain prediction results of the basic views, and integrating information through a view fusion algorithm to generate a preliminarily optimized view;
S4: processing a fused view through a graph attention network (GAT), applying a self-attention mechanism to enhance interactions and feature expressions among the nodes, and performing dynamic evaluation and weighted aggregation on features of neighbor nodes to generate an enhanced view with more information; and
S5: constructing a multi-layered observation set, using a stochastic block model (SBM) as a generative model, iteratively optimizing the graph structure using Bayesian inference and an expectation maximization (EM) algorithm to finally generate a high-quality graph structure, thereby enhancing performance and robustness of the GNN in downstream tasks.

The step S1 specifically includes:

S1.1: preprocessing obtained equipment data, and establishing a network structure graph G=(V, A, X, Y) based on a preprocessed dataset, where V is a node set composed of basic information of the equipment, A is an adjacency matrix of the nodes, X is a feature set of the nodes which is composed of attribute information of the equipment, and Y is an equipment label.

The step S2 specifically includes:

S2.1: extracting the two basic views from the original graph structure: an adjacency matrix and a transition matrix, performing preliminary processing on the two selected basic views, and acquiring view embeddings using the graph convolutional network (GCN):

$${Q}^{1} = σ ( GCN ( {V}_{1} , X ) )$$

$${Q}^{2} = σ ( GCN ( {V}_{2} , X ) )$$

where σ is a nonlinear activation function that introduces a nonlinear transformation to improve an expression ability and a complex data learning ability of the network.

S2.2: recalculating a probability of an edge in the graph structure using the node embeddings; for a target node, connecting an embedding thereof to an embedding of another node, and then normalizing weights of the nodes to obtain a probability of a connection between node pairs. This process being represented as follows:

$${w}_{ij} = W \cdot [ {q}_{i} ‖ {q}_{j} ] + a$$

$${p}_{ij}^{1} = \frac{exp ( {w}_{ij}^{1} )}{{\sum }_{k ∈ {S}^{1}} exp ( {w}_{ik}^{1} )}$$

where W represents a connection weight of nodes i and j, q represents the weights of the nodes, and a is a bias vector.

S2.3: obtaining a probability matrix P¹ based on a probability that each node pair has the edge; and combining the probability matrix with the original structure to obtain processed basic views. This process being represented as follows:

$${V}_{o}^{1} = {V}_{1} + {λ}^{1} \cdot {P}^{1}$$

where λ¹ is a fusion coefficient, which is related to a type of the dataset.

The step S3 specifically includes:

S3.1: fusing the views by adopting a method for assigning view weights based on prediction credibility, involving first obtaining the prediction results of the two basic views using a graph convolutional network (GCN):

$${O}^{1} = soft max ( GCN ( {V}_{o}^{1} , σ ( GCN ( {V}_{o}^{1} , X ) ) ) )$$

$${O}^{2} = soft max ( GCN ( {V}_{o}^{2} , σ ( GCN ( {V}_{o}^{2} , X ) ) ) )$$

where σ is a nonlinear activation function.

The view weights reflect the uncertainty based on predictive structure distribution. Specifically, when maximum values are the same, the larger a difference between the maximum value and other values, the smaller the uncertainty. Therefore, views with larger differences have higher weights. For example, between [0.7,0.1,0.2] and [0.4,0.35,0.3], the former has a larger difference from the maximum value and should be assigned a higher weight. Similarly, when the maximum values are the same, a view with a larger difference between the maximum value and the second highest value should have a higher weight. For example, between [0.8, 0.7, 0.3] and [0.8, 0.5, 0.1], the latter should be assigned a higher weight.

S3.2: based on the above principle, calculating the view weights represented as H in a fusion process as follows:

$${H}^{{v}_{i}} = {e}^{β ( γ {logn}^{1} + ( 1 - γ ) {logn}^{1} - {n}^{2} )}$$

where n¹ and n² represent the largest and second largest predictive distributions, and β and γ are hyper-parameters.

S3.3: normalizing the weights:

$${R}_{i}^{1} = \frac{{H}_{i}^{1}}{{H}_{i}^{1} + {H}_{i}^{2}} \qquad {R}_{i}^{2} = \frac{{H}_{i}^{2}}{{H}_{i}^{1} + {H}_{i}^{2}}$$

generating a final view of the nodes based on calculated weights:

$${V}^{★} = {R}^{1} \cdot {V}_{o}^{1} + {R}^{2} \cdot {V}_{o}^{2} .$$

The step S4 specifically includes:

S4.1: calculating an attention coefficient between the node pairs:

$${e}_{ij} = d ( [ {Mh}_{i} ‖ {Mh}_{j} ] ) , j ∈ {N}_{i}$$

where M is a shared parameter, h represents the node features, and d is a real number parameter used to project high-dimensional features of a connection into a real number field. This result needs to be normalized, and LeakyReLU is selected as an activation parameter:

$${α}_{ij} = \frac{exp ( LeakyReLU ( {e}_{ij} ) )}{{\sum }_{k ∈ {N}_{i}} exp ( LeakyReLU ( {e}_{ik} ) )}$$

where k represents all neighbor nodes of a certain node.

S4.2: multiplying the attention coefficient of each node pair with original node features, and adding the weights to obtain new node features:

$${{h}_{i}}^{′} = σ ( {\sum }_{j ∈ {N}_{i}} {α}_{ij} {Wh}_{j} )$$

Each node of three views (the two basic views and one fused view) is subjected to the above processing, and the node features in the graph structure are adaptively updated, such that the node features can aggregate information hidden behind relationships between the nodes.

The step S5 specifically includes:

S5.1: constructing the observation set using the GCN network, where a k-th layer aggregation rule of GCN is:

$${H}^{( k )} = σ ( {\tilde{D}}^{- \frac{1}{2}} {- \frac{1}{2}}^{} {H}^{( k - 1 )} {W}^{( k )} )$$

where Ã represents a normalized adjacency matrix, D is a diagonal matrix, σ is a nonlinear activation function, H^{(k-1)} and H^{(k)} represent node features of a k−1-th layer and a k-th layer, and W^{(k)} is a weight matrix related to the k-th layer, which promotes a linear transformation of the nodes.

After each aggregation, a current node representation captures structure information of this sequence. The node representations are then extracted to construct a kNN subgraph, and an original graph is placed therein to form a multi-layered observation set:

$$ℋ = \{ {H}^{( 0 )} , {H}^{( 1 )} , … , {H}^{( l )} \} .$$

S5.2: using the stochastic block model (SBM) as the generative model to simulate an optimal graph structure, a probability of a process of generating a simulated optimal graph structure G being formalized as:

$$P ( G \vert Ω , Z , {Y}_{L} ) = {\prod }_{i < j} {{Ω}_{{c}_{i} {c}_{j}}^{{G}_{ij}} ( 1 - {Ω}_{{c}_{i} {c}_{j}} )}^{1 - {G}_{ij}}$$

$${c}_{i} = \{ \begin{matrix}{y}_{i} & if {v}_{i} ∈ {𝒱}_{L} , \\ {z}_{i} & otherwise ,\end{matrix}$$

where Ω is a parameter of the SBM, Ω_{c}_{ᵢ}_{c}_{ⱼ} represents a probability that an edge exists between any node v in a community c and a node vj in a community cj, a variable Z represents an inherent feature set of the nodes in the original dataset, and YL corresponds to a label set of the nodes.

S5.3: currently mapping the simulated optimal graph structure generated by the SBM to the observation set, with rules of: comparing an observation graph with a high-quality graph, where if an edge exists in both graphs, respectively, a probability of this situation occurring is called a true good rate p; if an edge in the observation graph does not exist in the high-quality graph, a probability is called a false good rate q; and otherwise, a true error rate is 1−p, and a false error rate is 1−q.

Based on the rules, a probability of mapping a high-quality graph G to an observation graph 0 can be represented as:

$$P ( O \vert G , p , q ) = {\prod }_{i < j} {[ {{p}^{{E}_{ij}} ( 1 - p )}^{M - {E}_{ij}} ]}^{{G}_{ij}} \times {[ {q}^{{{E}_{ij} ( 1 - q )}^{M - {E}_{ij}}} ]}^{1 - {G}_{ij}}$$

where [p^{E}^{ᵢⱼ}(1−p)^{M-E}^{ᵢⱼ}]^{G}^{ᵢⱼ} represents a probability that an edge exists between a node i and a node j, and

$${q}^{{{E}_{ij} ( 1 - q )}^{M - {E}_{ij}}}$$

represents a situation that no edge exists in the graph structure.

S5.4: each mapping between an SBM graph and the observation set producing different possible values for the high-quality graph, and adding these values to obtain a parameterized posterior probability:

$$P ( Ω , p , q \vert O , Z , {Y}_{L} ) = {\sum }_{G} P ( G , Ω , p , q \vert O , Z , {Y}_{L} )$$

By maximizing the posterior probability, an adjacency matrix Q of the high-quality graph is calculated, which is then used to construct a determined high-quality graph:

$${Q}_{ij} = {\sum }_{G} P ( G ) {G}_{ij}$$

The structure is input into the downstream tasks to obtain fault detection results of the equipment.

### Embodiment 2

This embodiment provides a system for industrial equipment fault diagnosis based on graph structure joint optimization, including:
a data acquisition module, configured to acquire an original equipment dataset and construct an original graph structure based on the original equipment dataset;
an embedding module, configured to extract two basic views based on the original graph structure, calculate graph node embeddings of the basic views using a GCN, and recalculate a probability of an edge in the graph structure based on the graph node embeddings;
a fusion module, configured to perform view fusion based on the probability of the edge in the graph structure to obtain a preliminarily optimized view;
an enhancement module, configured to process a fused view through a GAT network to obtain an enhanced view; and
an optimization module, configured to use a stochastic block model as a generative model and iteratively optimize the graph structure using Bayesian inference and an expectation maximization algorithm to obtain a final graph structure.

A computer-readable storage medium, having a plurality of instructions stored therein, where the instructions are adapted to be loaded by a processor of terminal equipment and to execute a method for industrial equipment fault diagnosis based on graph structure joint optimization described above.

Terminal equipment, including a processor and a computer-readable storage medium, the processor being used for implementing various instructions, and the computer-readable storage medium being used for storing a plurality of instructions, where the instructions are adapted to be loaded by the processor and to execute a method for industrial equipment fault diagnosis based on graph structure joint optimization described above.

The above are preferred embodiments of this disclosure and are not intended to limit the scope of protection of this disclosure. Therefore, any equivalent changes made according to the structure, shape, and principle of this disclosure shall fall within the scope of protection of this disclosure.

What is claimed is:

1. A method for industrial equipment fault diagnosis based on graph structure joint optimization, comprising:
acquiring an original equipment dataset;
constructing an original graph structure based on the original equipment dataset;
extracting two basic views based on the original graph structure, calculating graph node embeddings of the basic views using a GCN, and recalculating a probability of an edge in the graph structure based on the graph node embeddings;
performing view fusion based on the probability of the edge in the graph structure to obtain a preliminarily optimized view;
processing a fused view through a GAT network to obtain an enhanced view;
using a stochastic block model as a generative model, and iteratively optimizing the enhanced view using Bayesian inference and an expectation maximization algorithm to obtain a final graph structure: wherein
the constructing an original graph structure based on the original equipment dataset comprises making collected original equipment data into a graph dataset suitable for network training, taking equipment as nodes, taking contact information between the equipment as the edge, and taking various data and attributes of the equipment as node features;
the extracting two basic views based on the original graph structure, calculating graph node embeddings of the basic views using a GCN comprises extracting the two basic views from the original graph structure: an adjacency matrix and a transition matrix, performing preliminary processing on the two selected basic views, and acquiring view embeddings using the graph convolutional network GCN:
$${Q}^{1} = σ ( GCN ( {V}_{1} , X ) )$$
$${Q}^{2} = σ ( GCN ( {V}_{2} , X ) )$$
wherein σ is a nonlinear activation function that introduces a nonlinear transformation to improve an expression ability and a complex data learning ability of the network;
the recalculating a probability of an edge in the graph structure based on the graph node embeddings comprises for a target node, connecting an embedding thereof to an embedding of another node, then normalizing weights of the nodes, calculating a probability that node pairs have an edge, combining overall probabilities to obtain a probability matrix, and combining the probability matrix with the original graph structure to obtain processed basic views;
the performing view fusion based on the probability of the edge in the graph structure to obtain a preliminarily optimized view comprises processing the fused view through a graph attention network GAT, applying a self-attention mechanism to enhance interactions and feature expressions among the nodes, and performing dynamic evaluation and weighted aggregation on features of neighbor nodes to generate an enhanced view with more information;
the applying a self-attention mechanism to enhance interactions and feature expressions among the nodes comprises calculating an attention coefficient between the node pairs:
$${e}_{ij} = d ( [ {Mh}_{i} ‖ {Mh}_{j} ] ) , j ∈ {N}_{i}$$
wherein M is a shared parameter, h represents the node features, and d is a real number parameter used to project high-dimensional features of a connection into a real number field; and
the using a stochastic block model as a generative model comprises using the stochastic block model SBM as the generative model to simulate an optimal graph structure, a probability of a process of generating a simulated optimal graph structure G being formalized as:
$$P ( G \vert Ω , Z , {Y}_{L} ) = {\prod }_{i < j} {{Ω}_{{c}_{i} {c}_{j}}^{{G}_{ij}} ( 1 - {Ω}_{{c}_{i} {c}_{j}} )}^{1 - {G}_{ij}}$$
$${c}_{i} = \{ \begin{matrix}{y}_{i} & if {v}_{i} ∈ {𝒱}_{L} \\ {z}_{i} & otherwise\end{matrix} ,$$
wherein Ω is a parameter of the SBM, Ω_{c}_{ᵢ}_{c}_{ⱼ} represents a probability that an edge exists between any node v in a community c and a node vj in a community cj, a variable Z represents an inherent feature set of the nodes in the original dataset, and YL corresponds to a label set of the nodes.

2. A system for industrial equipment fault diagnosis based on graph structure joint optimization, executing the method according to claim 1, wherein the system comprises:
a data acquisition module, configured to acquire an original equipment dataset and construct an original graph structure based on the original equipment dataset;
an embedding module, configured to extract two basic views based on the original graph structure, calculate graph node embeddings of the basic views using a GCN, and recalculate a probability of an edge in the graph structure based on the graph node embeddings;
a fusion module, configured to perform view fusion based on the probability of the edge in the graph structure to obtain a preliminarily optimized view;
an enhancement module, configured to process a fused view through a GAT network to obtain an enhanced view; and
an optimization module, configured to use a stochastic block model as a generative model and iteratively optimize the enhanced view using Bayesian inference and an expectation maximization algorithm to obtain a final graph structure.

3. A computer-readable storage medium, having a plurality of instructions stored therein, wherein the instructions are adapted to be loaded by a processor of terminal equipment and to execute the method according to claim 1.

4. Terminal equipment, comprising a processor and a computer-readable storage medium, the processor being used for implementing various instructions, and the computer-readable storage medium being used for storing a plurality of instructions, wherein the instructions are adapted to be loaded by the processor and to execute the method according to claim 1.
